(19) United States
(12) Patent Application Publication
(10) Pub. No.: US 2017/0004257 A1
(43) Pub. Date: Jan. 5, 2017

(54) SYSTEM AND METHOD FOR FACILITATING MULTI-SOURCE RETRIEVAL AND PRESENTATION OF HEALTH CARE INFORMATION

(71) Applicant: Systems Made Simple, Inc., Tysons Corner, VA (US)

(72) Inventors: Daniel J. RAMUNDA, JR., New Orleans, LA (US); Robert Timothy SAX, Geneva, NY (US); Ronald Stuart FISHBECK, Aroda, VA (US); Viet-Dung Nang NGUYEN, Salt Lake City, UT (US)

(21) Appl. No.: 14/790,999

(22) Filed: Jul. 2, 2015

(51) Int. Cl. G06F 19/00

(52) U.S. Cl. CPC G06F 19/322

(57) ABSTRACT

In an implementation, retrieval and presentation of health care information from multiple sources may be facilitated. Location references associated with health care information items may be stored. The location references may indicate locations at which the health care information items are stored. A consumer request for health care information associated with an individual may be received, and a first health care information item corresponding to the requested health care information may be determined. Based on resource criteria, a first location reference associated with the first health care information item may be selected, and used to obtain the first health care information item from a first location in one of the plurality of sources. Upon obtaining the first health care information item, presentation of the first health care information item may be provided via a feed to one or more consumers, and/or for display on one or more consumer devices.

### FIELD

The disclosure relates to a system and method for retrieval and presentation of health care information from multiple sources and, more particularly, to facilitating optimization of health care information retrieval, normalizing and storing health care information items from the multiple sources, associating health care information items of different item types, presenting health care information items based on such associations, etc.

### BACKGROUND

In recent years, government regulations and industry trends have caused a shift toward electronic storage of health care information. As such, several systems have been developed to enable health care providers to electronically input, store, and share health care information. Because health care providers utilize different systems to store health care information, an individual's health care information may be stored in a plurality of databases of the different systems. Although a particular health care information item related to an individual may be stored in multiple locations (e.g., in the plurality of databases), a typical health care information retrieval system generally relies on a single source (e.g., one of the databases) for obtaining the particular health care information item. As a result, the health care information retrieval system's ability to retrieve and present the health care information item is prone to delay or other negative impacts related to availability, performance, or other issues of its single source for the health care information item.

In addition, with numerous diverse systems, health care information related to an individual may be stored in various formats using different terminologies, resulting in disparate health care information. Thus, retrieval and presentation of health care information from multiple sources may be limited, especially when the various sources comprise disparate health care information. These and other drawbacks exist.

### SUMMARY

One aspect of the disclosure relates to a method and system for facilitating retrieval and presentation of health care information from multiple sources, in accordance with one or more implementations. In an implementation, a system may facilitate optimized retrieval of the health care information from the multiple sources. As an example, a particular health care information item associated with an individual may be stored at multiple locations within different sources (e.g., internal databases of the system, external databases of other systems, or other sources). Location references, each indicating at least one of the locations (at which the particular health care information item is stored), may be associated with the particular health care information item and stored in a search database of the system (e.g., to facilitate optimized retrieval of the health care information item). Responsive to a consumer request for health care information associated with the individual, for example, the particular health care information item may be determined to correspond to the requested health care information. As such, one of the stored location references may be selected for use in obtaining the particular health care information item (e.g., to satisfy the consumer request). The selection of the location reference (and, thus, the location from which the particular health care information item may be obtained) may be based on one or more resource criteria, such as a time criterion, a data type criterion, data standard criterion, location criterion, an availability criterion, and/or other criterion to optimize the retrieval of the particular health care information item. In some implementations, for example, the resource criteria may be used as a basis for determining which database and/or other source to query for a given health care information item.

As used herein, a health care information item associated with an individual may include health care information related to the individual. Such related health care information may include physician or clinician encounter notes, lab test information (e.g., lab tests performed and results), medication or prescription information, progress and/or status information (e.g., a progress report), patient-supplied information (e.g., related to diet, exercise, sleep, etc.), insurance claims information (e.g., claims for each of the lab tests performed, demographic information, personal information (e.g., height, weight, allergies, etc.), payment information (e.g., balance information, method of payment, etc.), information associated with other individuals and/or health care information relevant for the individual (e.g., information about how a disease the individual has progressed in other patients with the disease), and/or other information. The individual (with which the health care information item is associated) may include a patient, a subject of a clinical trial, a long-term care recipient, a nursing home resident, a resident of a psychiatric facility, a rehabilitation participant, and/or other individual.

In an implementation, health care information items may be obtained and/or presented based on their respective associations with other health care information items. For example, a clinical information item (e.g., lab tests performed) associated with an individual and an insurance information item (e.g., an insurance claim for each of the lab tests performed) associated with the individual may be associated with one another, and their association may be stored in a database or other data store. In one use case, responsive to a consumer request from a consumer for insurance claims associated with the individual, the insurance information item may be obtained for presentation to the consumer. In response, the clinical information item may also be obtained for presentation to the consumer (together with the associated insurance information item) based on a determination that the clinical information item is associated with the insurance information item. In this way, for example, the association of health care information items and presentations based on the foregoing association (e.g., presentation of associated insurance information items and clinical information items) may enable administrators or others to more effectively detect health care fraud.

In an implementation, health care information items may be obtained from a plurality of sources and then processed to generate sets of descriptors describing the health care information items. Once generated, the sets of descriptors (e.g., metadata associated with the health care information items) may be stored in a database in association with the health care information items. The sets of descriptors may then be utilized as a search tool to determine whether one or more of the health care information items are relevant to consumer requests for health care information. As an example, a health care information item may be determined to correspond to health care information requested by a consumer based on a determination that its associated descriptors match one or more keywords associated with the consumer request.

In an implementation, health care information items obtained from a plurality of sources may be normalized such that they can be displayed and/or analyzed together in a cohesive manner. Health care information items from a plurality of sources may include different formats, languages, codes, and/or other issues. Normalizing the health care information items may include fixing issues with the health care information items, standardizing the health care information items, translating the health care information items, and/or other actions. Once normalized, the health care information items may be stored at one or more locations in one or more databases or other data store so that they can later be obtained in response to a consumer request.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular forms of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 illustrates a system for facilitating retrieval and presentation of health care information from multiple sources, in accordance with an implementation.

FIGS. 2 and 3 illustrate use cases of optimized health care information retrieval, in accordance with various implementations.

FIG. 4 illustrates a graphical user interface for presenting one or more health care information items, in accordance with an implementation.

FIGS. 5 and 6 illustrate methods for facilitating retrieval and presentation of health care information from multiple sources, in accordance with various implementations.

### DETAILED DESCRIPTION

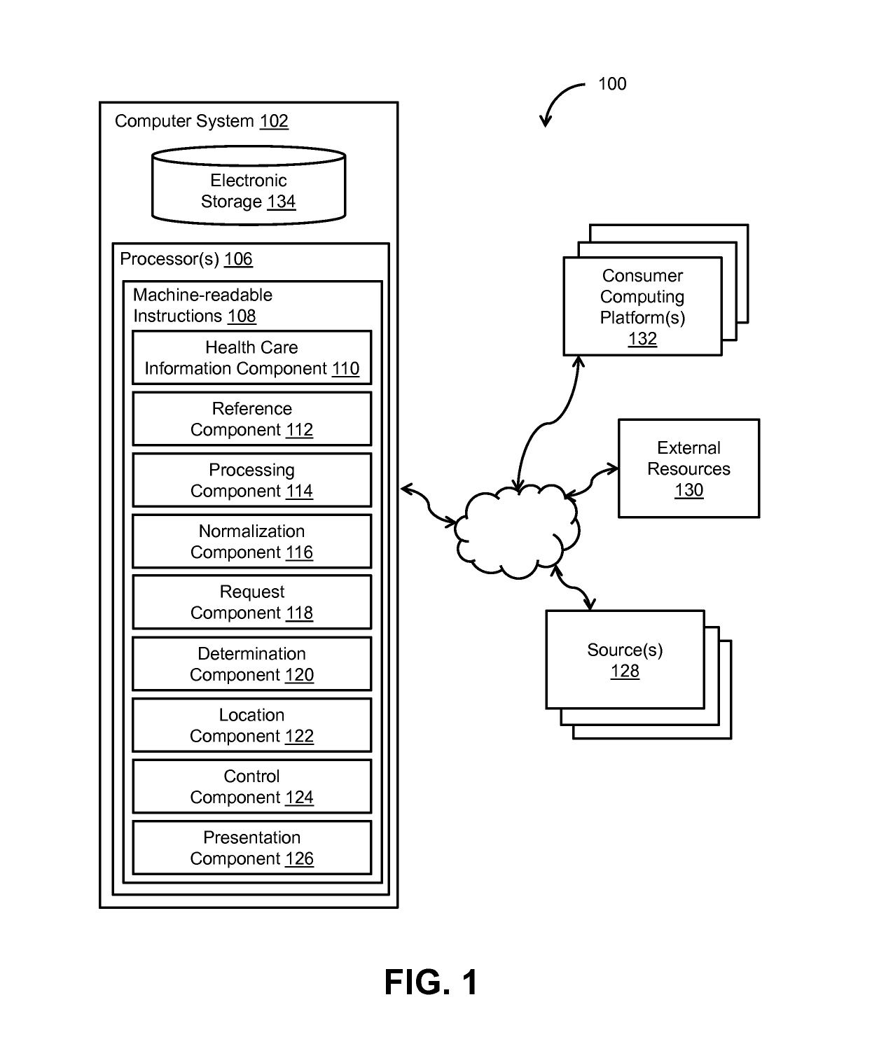

FIG. 1 illustrates a system 100 for facilitating retrieval and presentation of health care information from multiple sources, in accordance with an implementation. In some implementations, system 100 may include computer system 102 (e.g., one or more servers). Computer system 102 may be configured to communicate with one or more consumer computing platform(s) 132 in accordance with a web services architecture, a client/server architecture, and/or other data transport methods. The consumers may access the system via consumer computing platform(s) 132.

Computer system 102 may include one or more servers. The one or more servers may be configured to execute machine-readable instructions 108 to facilitate retrieval and presentation of health care information from multiple sources. The machine-readable instructions may include one or more of a health care information component 110, a reference component 112, a processing component 114, a normalization component 116, a request component 118, a determination component 120, a location component 122, a control component 124, a presentation component 126, and/or other components.

Optimization of Health Care Information Retrieval

In an implementation, computer system 102 may obtain health care information items for presentation to a consumer, based on one or more stored location references, responsive to a consumer request for health care information. Computer system 102 may store location references associated with health care information items. The location references, for example, may indicate locations in a plurality of sources at which the health care information items may be stored. At least one of the health care information items may be associated with multiple ones of the location references. Computer system 102 may also locally store healthcare information items from prior consumer requests, or may have received healthcare information items proactively from Sources (128). Computer system 102 may receive a consumer request for health care information associated with an individual.

A first health care information item that may correspond to the requested health care information may be determined based on the consumer request. Based on one or more resource criteria, a first location reference associated with the first health care information item may be selected. In an implementation, the first health care information item may be associated with multiple location references that may indicate multiple locations in the plurality of sources at which the first health care information item is stored. Selecting the first location reference may, for example, comprise selecting the first location reference from the multiple location references based on the one or more resource criteria. The resource criteria, for example, include one or more of a time criterion, data type criterion, data standard criterion, location criterion, an availability criterion, and/or other criterion. The first location reference may indicate the first location and may be used to obtain the first health care information item. Computer system 102 may be configured to obtain the first health care information item from the first location based on the first location reference. Computer system 102 may be configured to effectuate presentation of the first health care information item. In some implementations, computer system 102 may be configured to effectuate presentation of the first health care information item for display on one or more consumer devices (e.g., consumer computing platform(s) 132). In some implementations, computer system 102 may be configured to effectuate presentation of the first health care information item by providing the first health care information item via a feed to one or more consumers. Consumers may include one or more of a user (e.g., using a user interface), a system (e.g., an analytics system), a rules engine, a database, a workflow, and/or other consumer that may make use of the health care information item(s).

In an implementation, health care information component 110 may be configured to obtain health care information items. In some implementations, the health care information items may be obtained responsive to a consumer request for health care information as described herein. In some implementations, health care information component 110 may be configured to obtain health care information items automatically (e.g., for processing, normalizing, and/or storing). The health care information items may be obtained from a plurality of sources (e.g., internal databases or other data stores, external systems, etc.). The plurality of sources may include one or more of electronic medical record platforms, electronic health record platforms, personal health record platforms, public reference data platforms, private reference data platforms, patient input platforms, and/or other sources. Health care information items may include one or more of clinical information items, insurance information items, public reference information items, private reference information items, patient-generated information items, and/or other information.

Clinical information items may include one or more of physician or clinician encounter notes, lab test information (e.g., lab tests performed and results), medication or prescription information, progress and/or status information (e.g., one or more progress report(s)), demographic information, personal information (e.g., height, weight, allergies, etc.) and/or other clinical information. Insurance information items may include insurance claims information (e.g., claims for each of the lab tests performed), insurance coverage information, payment information (e.g., balance information), and/or other information.

Public reference information items may include one or more of medical database information for coding and terminologies, information on symptoms, conditions, and diagnoses, social media data, demographics or population data, governmental guideline information, public health information, and/or other public reference information. Private reference information items may include one or more of information contained in a third party solution (e.g., THOMPSON REUTERS®), customer internal reference information, and/or other private reference information.

Patient-generated information items may include information recorded by the patient and/or by one or more monitoring devices. Patient-generated information items recorded by the patient may include one or more of exercise, diet, sleep, stress, and/or other information recorded by the patient via one or more applications and/or websites. Patient-generated information from patient-monitoring devices may include prescribed and/or standard patient-monitoring devices. For example, patient-monitoring devices may include one or more of a heart monitor, a blood pressure monitor, a blood glucose monitor, a respiratory monitor, a body temperature monitor, a fitness monitor (e.g., a FITBIT®), a heart rate monitor, a sleep monitor, and/or other patient-monitoring devices.

In an implementation, reference component 112 may be configured to store location references associated with health care information items. The location references may indicate locations in a plurality of sources (128) at which one or more of the health care information items may be stored. In some implementations, the plurality of databases may include one or more system data stores located, for example, in electronic storage 134. Electronic storage (134) can take any number of forms including relational, document, structured, and/or non-structured depending on the type of health care information and intended use. The health care information items may be associated with multiple ones of the location references. For example, a given health care information item may be located in multiple sources. As such, continuing the example, the given health care information item may include multiple location references describing individual ones of the locations in the plurality of databases at which the given health care information item may be stored. The references, by way of a non-limiting use example, may be used as a pointer to locate the given health care information item.

In an implementation, processing component 114 may be configured to process the health care information items. Processing component 114 may be configured to process the health care information items responsive to health care information component 110 automatically obtaining the health care information items. Processing component 114 may be configured to process one or more health care information items to generate sets of descriptors associated with the health care information items. Each one of the sets of descriptors may comprise at least one descriptor describing at least one of the health care information items to which the one set of descriptors corresponds. Processing component 114 may be configured to store the sets of descriptors associated with the health care information items. The sets of descriptors may be stored in one or more system data stores (e.g., electronic storage 134) and/or other sources (e.g., plurality of source(s) 128).

In an implementation, processing component 114 may be configured to process the health care information items (e.g., the health care information items obtained from a plurality of sources) to determine corresponding health care information items. For example, a health care information item including clinical information may correspond to a health care information item including insurance information. Processing component 114 may associate a first health care information item with a second health care information item based on a determination that the first health care information item corresponds to the second health care information item.

For example, processing component 114 may be configured to pull an individual clinical information item and look for an individual insurance information item that is associated with the individual clinical information item. By way of non-limiting use example, a single given lab result for a patient obtained based on a consumer request may be associated with a single given insurance claim that corresponds to the single given lab result for the patient. Continuing the non-limiting use example, the single given lab result may be presented together with the corresponding single given insurance claim.

In an implementation, normalization component 116 may be configured to normalize one or more health care information items (e.g., health care information items obtained from the plurality of source(s) 128). In some implementations, normalization component 116 may be configured to normalize health care information items responsive to health care information component 110 automatically obtaining the health care information items. In some implementations, normalization component 116 may be configured to normalize the health care information items obtained by computer system 102 responsive to a consumer request for health care information. In some implementations, one or more health care information items (e.g., medical record(s)) may use various medical terminologies and/or codes (e.g., ICD-9, ICD-10, SNOMED CT®, Current Procedural Terminology (CPT), etc.), and normalizing the health care information items may standardize the terminology and coding. For example, multiple health care information items may be normalized after being automatically obtained by health care information component 110. As such, responsive to a consumer request, the system may search normalized data. By way of another example, a given health care information item may be normalized once it is obtained from a given location in response to a consumer request before presentation to the consumer.

Normalizing one or more health care information items may include fixing issues with the health care information items, standardizing the health care information items, translating the health care information items, and/or other actions associated with the health care information items.

For example, to translate the health care information item, normalization component 116 may be configured to maintain standard vocabularies, ontologies, hierarchies, and/or classifications through subscriptions, as well as custom translations. In an implementation, normalizing the health care information items may include one or both of semantic processing or natural language processing in order to provide a deeper analysis and understanding of non-coded information. For example, the health care information items may be translated from multiple terminologies and codes (e.g., ICD-9, ICD-10, SNOMED CT®, Current Procedural Terminology (CPT), etc.) into one common language code. In an implementation, normalization component 116 may be configured to store the normalized health care information items at one or more locations in at least one of the plurality of databases. The plurality of databases may include one or more system data stores (e.g., electronic storage 134) and/or other databases (e.g., plurality of source(s) 128).

In an implementation, request component 118, may be configured to receive a consumer request for health care information. The health care information may be associated with one or more of an individual, a group of individuals, a symptom, a diagnosis, a medication, a trend, and/or other information related to health care. In an implementation, request component 118 may be configured to receive a consumer request for health care information from a consumer via a search engine interface displayed on a consumer computing platform (e.g., consumer computing platform(s) 132).

In an implementation, determination component 120 may be configured to determine a first health care information item that corresponds to the requested health care information. In an implementation, determination component 120 may be configured to determine a first set of descriptors that correspond to the requested health care information. In some implementations, the first health care information item may be determined to correspond to the requested health care information item based on one or more of the consumer request, the sets of descriptors, and/or other information. As an example, the first health care information item may be determined to correspond to the requested health care information based on the first health care information item being associated with the first set of descriptors.

In an implementation, determination component 120 may be configured to determine a second health care information item associated with the first health care information item. The second health care information item may be determined based on the consumer request. The first health care information item may include a first clinical information item. The second health care information item may comprise a first insurance information item associated with the first clinical information item.

In an implementation, location component 122 may be configured to select a first location reference associated with the first health care information item. The first location reference may be selected based on one or more resource criteria. The first location reference may be used to obtain the first health care information item from a first location in one of the plurality of databases. The first location may be indicated by the first location reference. As such, for example, a given location reference indicating a given location of a given health care information item may be selected based on one or more resource criteria. In some implementations, for example, sources and/or databases may be registered with defining parameters for directing queries (e.g., by selecting location references). Continuing the example, the defining parameters may be associated with one or more resource criteria.

In an implementation, the first health care information item may be associated with multiple location references that indicate multiple locations in the plurality of sources at which the first health care information item may be stored. As such, selecting the first location reference may comprise selecting the first location reference from the multiple location references associated with the first health care information item. Selecting the first location reference may be based on the one or more resource criteria. In some implementations, the one or more resource criteria may include one or more defining parameters of one or more of the multiple locations in the plurality of sources and/or one or more of the plurality of sources. In some implementations, the resource criteria may be used to determine which source (e.g., location, database, etc.) to obtain a given health care information item from. For example, the resource criteria may be used as a basis for determining which database and/or other source to query for a given health care information item.

In an implementation, the resource criteria may comprise one or more of a time criterion, data type criterion, data standard criterion, location criterion, an availability criterion, and/or other resource criteria. As an example, a time criterion may comprise a criterion indicating time relevance information for selecting location references based on an associated date. The time relevance information may indicate whether the most recent available information may be more relevant, whether information associated with a specific date or range of dates may be more relevant, and/or other time relevance information. In one scenario, for instance, a particular location reference (indicating a location for obtaining a health care information item) may be selected as a location reference to be used to obtain the health care information item based on a determination that obtaining the health care information from the location indicated by the location reference would provide more recent health care information and/or more relevant health care information than obtaining the health care information item from other locations indicated by other location references. By way of non-limiting example, a health care information item associated with a patient blood pressure reading from ten years ago is probably not relevant during an emergency room visit, but may be relevant if plotting a patient history. As such, the time criterion may be used to optimize which location reference (e.g., pointing to a blood pressure test result of five days ago or pointing to a blood pressure test result of ten years ago) would provide the most time relevant health care information item.

A data type criterion may comprise a criterion indicating the type of health care information being sought. As such, the data type criteria may be used to select location references that indicate locations associated with databases having certain types of health care information. As such, for example, if each of a plurality of sources includes multiple types of health care information items, a first location reference indicating a first source that includes first type of health care information and/or at least a certain amount of a first type of health care information may be selected as a location reference to be used to obtain the given health care information item over a second location reference indicating a second source that includes a second type of health care information and/or only a small amount of the first type of health care information. By way of non-limiting example, if a specific consumer request is for lab results, location references indicating a source dedicated exclusively to another type of data, such as diagnostic imaging, may not be selected.

A data standard criterion may comprise a criterion indicating a data standard for particular location references. Numerous health care and technical standards are used to represent, transmit, and store health care information items. As such, a data standard criterion may be used to determine which location references should be selected based on the data standards used for a particular source the location reference indicates. By way of non-limiting example, if a consumer request for health care information indicates an FHIR® standard, location references indicating a source that specifically and exclusively uses FHIR® resources to represent real-time lab results may be selected based on a data standard criterion. As such, continuing the example, the selected source may be queried. In another example, data standard criterion may be used by computer system 102 to formulate and/or format a query for one or more health care information items.

A location criterion may comprise a criterion indicating a specific preferred location from which to retrieve health care information items. By way of non-limiting example, if a patient is visiting his primary care physician and mentions he stopped at an emergency room on vacation, the location criterion may be used to direct a query (e.g., select a location reference associated with the specific preferred location) to the emergency room hospital's EHR (Electronic Health Record) system to retrieve those medical records (e.g., a health care information item) associated with the patient.

An availability criterion may comprise a criterion indicating a preference for location references that indicate locations within databases that are currently available for access. As such, for example, when a given database (at which a given health care information item may be stored) is unavailable (e.g., down, unreachable due to network issues, permission issues, etc.), a location reference indicating a given location within a different source (that is available for access) may be chosen for use in obtaining the given health care information item.

Thus, in an implementation, a first location reference may be selected (for use in obtaining a first health care information item) from the multiple location references associated with the first health care information item based on one or more of time criteria, data type criterion, data standard criterion, location criterion, an availability criterion, and/or other resource criteria. In an implementation, the resource criteria may be used to choose a location (e.g., a source) based on an optimal combination of one or more resource criteria. By way of non-limiting use example, time relevance (e.g., time criterion) and a data type criterion may be used to determine the optimal location to query and/or from which to obtain a health care information item.

In an implementation, health care information component 110 may be configured to obtain the first health care information item from the first location. Health care information component 110 may be configured to obtain the first health care information item from the first location based on the first location reference (e.g., indicating the first location). In an implementation, the first location may include a location in one of the plurality of sources.

In an implementation, health care information component 110 may be configured to obtain one or more normalized health care information items. As such, obtaining the first health care information item may comprise obtaining one of the normalized health care information items based on the first location reference.

In an implementation, health care information component 110 may be configured to obtain the second health care information item from a second location in one of the plurality of sources. Health care information component 110 may be configured to obtain the second health care information item from the second location responsive to determination component 120 determining a second health care information item associated with the first health care information item. The second health care information item may include a first insurance information item. For example, the second location may include a location associated with an insurance carrier. The first health care information item may include a first clinical information item. The first insurance information item may be associated with the first clinical information item. In an implementation, obtaining the first health care information item may comprise obtaining, based on the first location reference, one of one or more normalized health care information items.

In an implementation, presentation component 126 may be configured to effectuate presentation of the first health care information item. In some implementations, effectuating presentation of the first health care information item may include effectuating presentation for display on one or more consumer devices (e.g., consumer computing platform(s) 132). In some implementations, effectuating presentation of the first health care information item may include providing a feed including the first health care information item. As such, in some implementations, presentation component 125 may be configured to provide a feed to one or more consumers. Providing a feed including the first health care information item may include providing a feed such that the first health care information item may be used in one or more processing components (e.g., a rules engine and/or analytics system/component). In an implementation, presentation component 126 may be configured to effectuate presentation of one or more normalized health care information items (e.g., the normalized first health care information item). Presentation component 126 may be configured, according to an implementation, to effectuate presentation of the second health care information item with the presentation of the first health care information item. As such, the first clinical information item may be presented with the first insurance information item based on the association of the first clinical information item and the first insurance information item with one another.

Health Care Information Retrieval, Management, and Analysis (46) In an implementation, storing, accessing, normalizing, processing, presenting, analyzing, and/or other actions performed or enabled by system 100 may be performed and/or monitored according to one or more rules. The rules may include one or more types including clinical rules, payment/insurance rules, analytics rules, authorization rules, information normalization rules, presentation rules, and/or other types of rules. The rules may be customizable and/or consumer/user configurable. The rules may ensure that the actions performed and/or enabled by system 100 are compliant with regulations for the National Institute of Standards and Technology (NIST), the Health Insurance Portability and Accountability Act (HIPAA), and/or other regulations for health care data integrity and security.

In an implementation, clinical rules, for example, may describe parameters for assisting clinicians in identifying potential and/or occurring issues. For example, clinical rules may include parameters defining one or more combinations of symptoms and/or diagnoses, combinations of medications, allergies, negative or positive trends, and/or other possible conditions system 100 may monitor and/or alert a consumer of. In some implementations, clinical rules may change over time as consumers learn and/or adapt to patient demographics and trends. Personal preferences and/or tolerances may be included by the rules.

In an implementation, payment/insurance rules may describe, for example, one or more of parameters for processing insurance claims, clinical information supporting insurance claims, payment claim information, or other payment and/or insurance information. For example, the payment/insurance rules may include parameters to assess the existence and/or validity of clinical data prior to the claims activity. As such, the payment/insurance rules may help system 100 detect fraud.

In an implementation, analytics rules may, for example, describe parameters for one or both of processing or normalizing health care information items to determine analytics for one or more of a given individual, a population of patients, a diagnosis, symptoms, or other subjects. Analytics may include one or more of descriptive analytics, predictive analytics, prescriptive analytics, causal analytics, and/or other analytics as described herein.

In an implementation, authorization rules may describe parameters for managing access to certain health care information items, records, and/or functions of system 100 for individual consumers. For example, a given consumer may only have access to a portion of health care information items associated with patient records and may not be authorized to access health care information items including full medical records of patients.

In an implementation, information normalization rules may include, for example, one or more rules describing parameters for reviewing health care information items, identifying issues with health care information items, fixing issues with health care information items, standardizing health care information items, translating health care information items, or other actions related to normalizing health care information items. For example, information normalization rules may include one or more of preferred vocabularies, ontologies, hierarchies, classifications, custom translations, or other information normalization rules.

In an implementation, presentation rules may describe, for example, one or more parameters for presenting one or more health care information items for display on one or more consumer devices (e.g., consumer computing platform(s) 132). For example, the presentation rules may indicate that the health care information items should be presented in one or more of a tabular, graphical, timeline, or other configuration.

In an implementation, control component 124, may be configured to analyze one or more health care information items. Control component 124 may be configured to determine analytics automatically and/or based on one or more rules. In other implementations, control component 124 may be configured to determine analytics in response to one or more consumer requests for health care information.

Analytics may include one or more of descriptive analytics, predictive analytics, prescriptive analytics, causal analytics, and/or other analytics. Descriptive analytics may describe health care information items having one or more specific characteristics. By way of non-limiting use example, descriptive analytics may include a quantity of male patients, over the age of 50, with a body mass index (BMI) over 30 that have been diagnosed with hypertension. By way of another non-limiting use example (e.g., for a hospital employing system 100), descriptive analytics may include a quantity of patients diagnosed with heart disease that are readmitted within 30, 60, and 90 days of discharge, grouped by age, gender, and facility.

In an implementation, predictive analytics may include recognized trends and/or extrapolated results that predict future activities. In some implementations, predictive analytics may be dependent on causality assumptions. The causality assumptions may be defined according to one or more rules. This can be used for capacity planning, proactive health interventions, and more effective health care to improve patient outcomes. These are a different set of tools and mathematical approaches, and are highly dependent on normalized or standardized health care information items and solid assumptions of causality. To continue the example above, obtaining health care information items about readmissions, combined with assumptions of population health, system 100 may try to predict levels of future ER visits over time to plan for clinician and equipment availability needs.

In an implementation, prescriptive analytics may include a determination of areas of a patient population and/or an organization that are most likely, if treated and/or supplied the necessary resources, to produce the most efficient and/or effective outcomes. In a non-limiting use example combining various analytics corresponding to health care information items associated with a patient population, a health system might use descriptive analytics to understand a population (e.g., obese and diabetic patients), predictive analytics to perform a what-if analysis, and prescriptive analytics to help narrow in on the specific population that, if treated, would provide the most effective outcomes.

In an implementation, causal analytics may use analytical techniques to establish causality of factors, as opposed to correlational relationships. An example may include the occurrence of sleep apnea diagnoses, existence of hypertension, and existence of asthma. Continuing the example, system 100 may be configured to determine that one or more of these diagnoses causes another.

In an implementation, presentation component 126 may be configured to effectuate presentation of the analytics (e.g., various analytics determined by control component 124). The analytics may include the one or more health care information items. In some implementations, presentation component 126 may be configured to effectuate presentation of the analytics with presentation of the one or more health care information items.

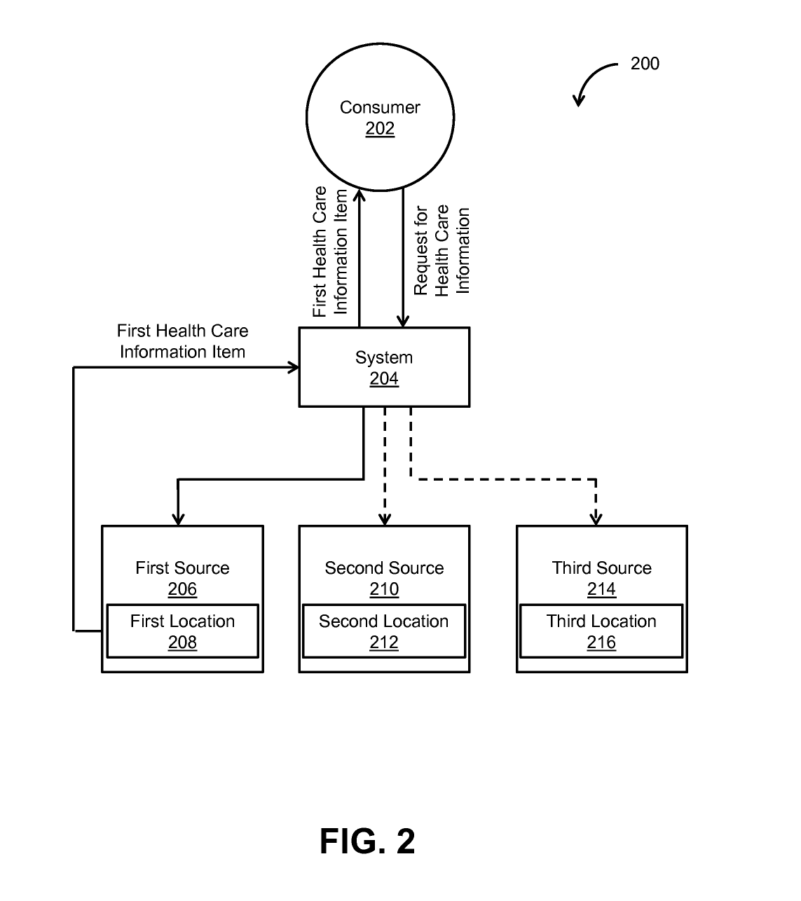

FIG. 2 illustrates a use case of an optimized health care information retrieval flow process, in accordance with various implementations. In an implementation, health care information retrieval flow process 200 may include communicating and/or transferring health care information items between one or more of a consumer 202, a system 204, a first source 206, a first location 208, a second source 210, a second location 212, a third source 214, a third location 216, and/or other locations or sources. System 204 may include one or more components that are the same as or similar to one or more components of system 102.

In an implementation, consumer 202 may submit a request for health care information to system 204. System 204 may receive the request for health care information and determine a first health care information item that corresponds to the requested health care information. System 204 may select a first location reference associated with the first health care information item that is to be used to obtain the first health care information item from one or more of first location 208, second location 212, third location 216, or another location in one or more of a first source 206, second source 210, third source 214, and/or other sources. For example, the first location reference associated with the first health care information item may be used to obtain the first health care information item from the first location 208 in the first source 206. Continuing the example, first location 208 may be indicated by the first location reference. Based on the selection of the first location reference, system 204 may obtain the first health care information item from first location 208. System 204 may effectuate presentation of the first health care information item to consumer 202.

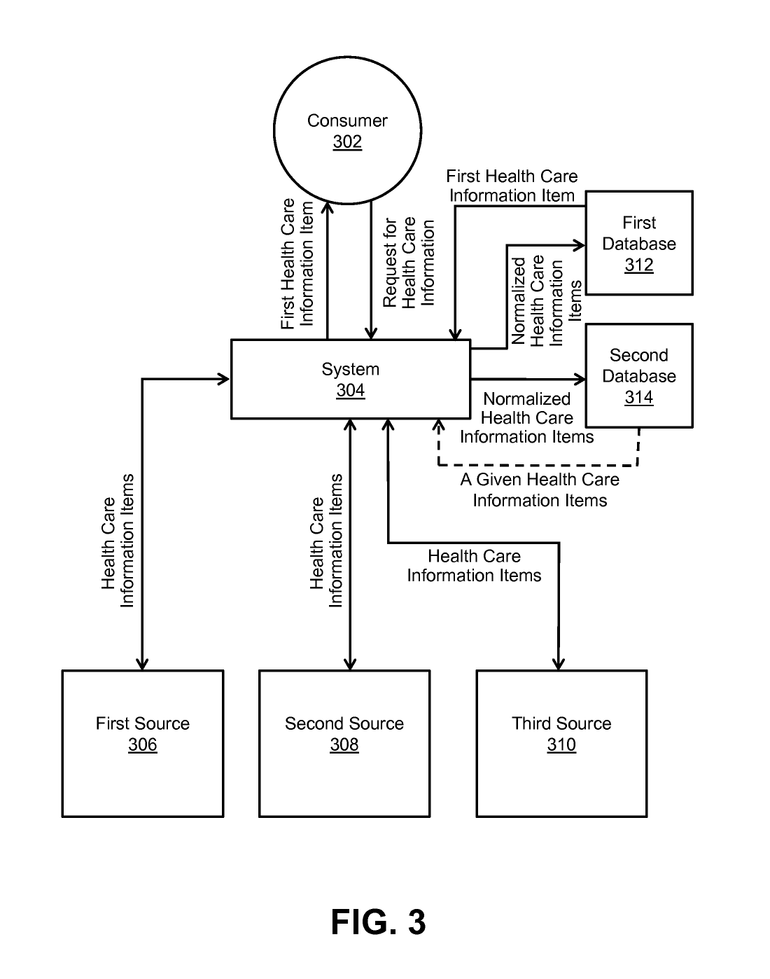

FIG. 3 illustrates a use case of an optimized health care information retrieval flow process, in accordance with various implementations. In an implementation, health care information retrieval flow process 200 may include communication and/or transfer of health care information items between one or more of a consumer 302, a system 304, a first source 306, a second source 308, a third source 310, a first database 312, a second database 314, or other sources, databases, locations, or systems. System 304 may include one or more components that are the same as or similar to one or more components of system 102.

In an implementation, system 304 may obtain health care information items from a plurality of sources. A plurality of sources may include, for example, one or more of first source 306, second source 308, third source 310, or other sources. System 304 may be configured to normalize the health care information items obtained from the plurality of sources. The normalized health care information items may be stored at one or more locations in one or more of a plurality of databases (e.g., internal databases or other data stores). The plurality of databases, for example, may include one or more of first database 312, second database 314, or other data stores. Consumer 302 may submit a request for health care information to system 304. System 304 may receive the request for health care information and determine a first health care information item that corresponds to the requested health care information. System 304 may select a first location reference associated with the first health care information item that is to be used to obtain the first health care information item from one or more locations in one or more of first database 312, second database 314, or other data stores. For example, the first location reference associated with the first health care information item may be used to obtain the first health care information item from the first database 312. Continuing the example, a first location in first database 312 where the first health care information item is stored may be indicated by the first location reference. System 304 may obtain the first health care information item from the first location in first database 312. System 304 may effectuate presentation of the first health care information item obtained to consumer 302.

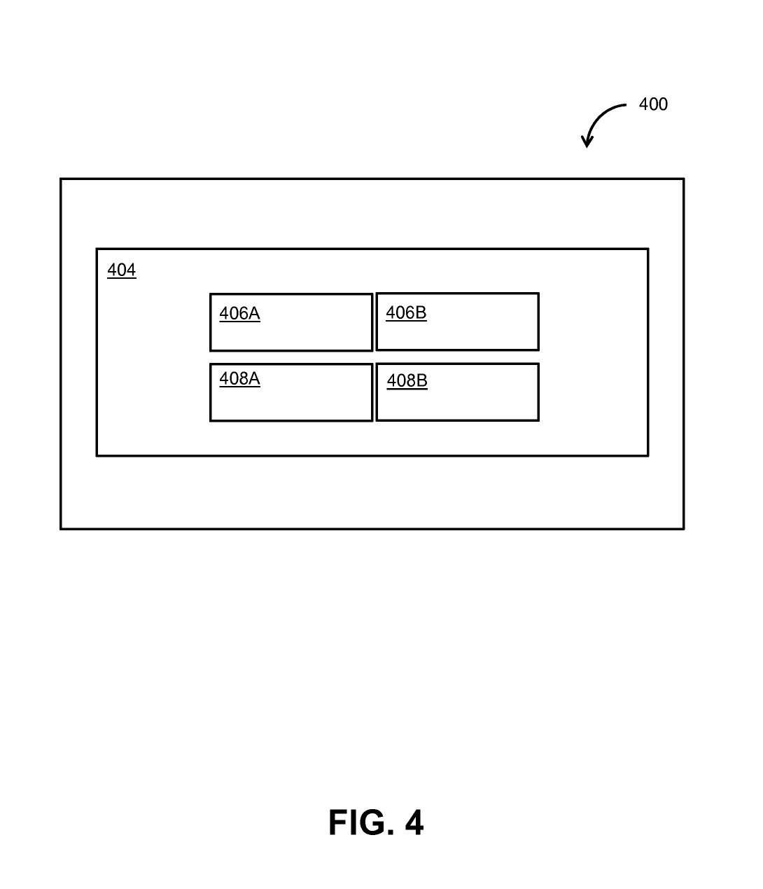

FIG. 4 illustrates a graphical user interface for presenting one or more health care information items, in accordance with an implementation. Graphical user interface 400 may include one or more windows (e.g., window 404) for presenting the health care information items. In an implementation, multiple health care information items may be presented together in window 404. The health care information items may include clinical information items 406A, 408A, etc., and insurance information items 406B, 408B, etc. In an implementation, individual insurance information items may be associated with individual clinical information items. As illustrated in FIG. 4, for example, clinical information item 406A and insurance information item 406B may be associated with one another, and clinical information item 406A may be presented with insurance information item 406B based on their association with one another. Likewise, for example, clinical information item 408A and insurance information item 408B may be associated with one another, and clinical information item 408A may be presented with insurance information item 408B based on their association with one another.

By way of non-limiting use example, a consumer request for an individual's latest test results may cause one or more of the individual's clinical information items to be obtained along with the respective insurance information items (e.g., insurance claims) associated with the clinical information items. Continuing the non-limiting use example, the insurance information items may be obtained and presented with the clinical information items based on a determination that each of the obtained insurance information item is associated with at least one of the clinical information items. As such, in the aforementioned non-limiting use example, the insurance information items may be obtained with the clinical information items based on a single consumer request for the individual's clinical information as opposed to independent queries for each set of information.

Returning to FIG. 1, computer system 102 (e.g., one or more servers), consumer computing platform(s) 132, external resources 130, source(s) 128, and/or other components may be operatively linked via one or more electronic communication links. For example, such electronic communication links may be established, at least in part, via a network such as the Internet and/or other networks. It will be appreciated that this is not intended to be limiting and that the scope of this disclosure includes implementations in which computer system 102, consumer computing platform(s) 132, external resources 130, source(s) 128, and/or other components may be operatively linked via some other communication media.

A given consumer computing platform 132 may include one or more processors programmed to execute computer program components. The computer program components may be programmed to enable an expert, consumer, and/or user associated with a given consumer computing platform 132 to interface with system 100 and/or external resources 130, and/or provide other functionality attributed herein to consumer computing platform(s) 132. By way of non-limiting example, consumer computing platform 132 may include one or more of a computing system, a desktop computer, a laptop computer, a handheld computer, a netbook, a smartphone, a gaming console, and/or other computing platforms.

External resources 130 may include sources of information, hosts and/or data stores outside of system 100, external entities participating with system 100, and/or other resources. In some implementations, some or all of the functionality attributed herein to external resources 130 may be provided by resources included in system 100.

Source(s) 128 may include one or more systems, platforms, files, and/or data stores outside of system 100, and/or other resources in communication with system 100. In some implementations, source(s) 128 may include the plurality of databases such that one or more locations at which health care information items are stored are locations in one or more of source(s) 128.

In some implementations, computer system 102 may include electronic storage 134, one or more processors 106, machine-readable instructions 108, and/or other components. Computer system 102 may include communication lines, or ports to enable the exchange of information with a network and/or other computing platforms. Illustration of computer system 102 in FIG. 1 is not intended to be limiting. Computer system 102 may include a plurality of hardware, software, and/or firmware components operating together to provide the functionality attributed herein to computer system 102. For example, computer system 102 may be implemented by a cloud of computing platforms operating together as computer system 102.

Electronic storage 134 may comprise non-transitory storage media that electronically stores information. The electronic storage media of electronic storage 134 may include one or both of system storage that is provided integrally (i.e., substantially non-removable) with computer system 102 and/or removable storage that is removably connectable to computer system 102 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 134 may include one or more virtual storage resources (e.g., cloud storage, a virtual private network, and/or other virtual storage resources). Electronic storage 134 may store software algorithms, information determined by processor(s) 106, information received from computer system 102, information received from consumer computing platform(s) 132, and/or other information that enables computer system 102 to function as described herein.

Processor(s) 106 may be programmed to provide information processing capabilities in computer system 102. As such, processor(s) 106 may include one or more of a digital processor, an analog processor, a digital circuit designed to process information, an analog circuit designed to process information, a state machine, and/or other mechanisms for electronically processing information. Although processor(s) 106 is shown in FIG. 1 as a single entity, this is for illustrative purposes only. In some implementations, processor(s) 106 may include a plurality of processing units. These processing units may be physically located within the same device, or processor(s) 106 may represent processing functionality of a plurality of devices operating in coordination. Processor(s) 106 may be programmed by machine-readable instructions 108 to execute components 110, 112, 114, 116, 118, 120, 122, 124, 126, and/or other components. Processor(s) 106 may be programmed to execute components 110, 112, 114, 116, 118, 120, 122, 124, 126, and/or other components by software; hardware; firmware; some combination of software, hardware, and/or firmware; and/or other mechanisms for configuring processing capabilities on processor(s) 106. As noted, in certain implementations, a consumer computing platform 132 may include one or more computer program components that are the same as or similar to the computer program components of computer system 102. Consumer computing platform 132 may include one or more processors that are the same as or similar to processor(s) 106 of computer system 102 to execute the machine-readable instructions including the computer program components of consumer computing platform 132.

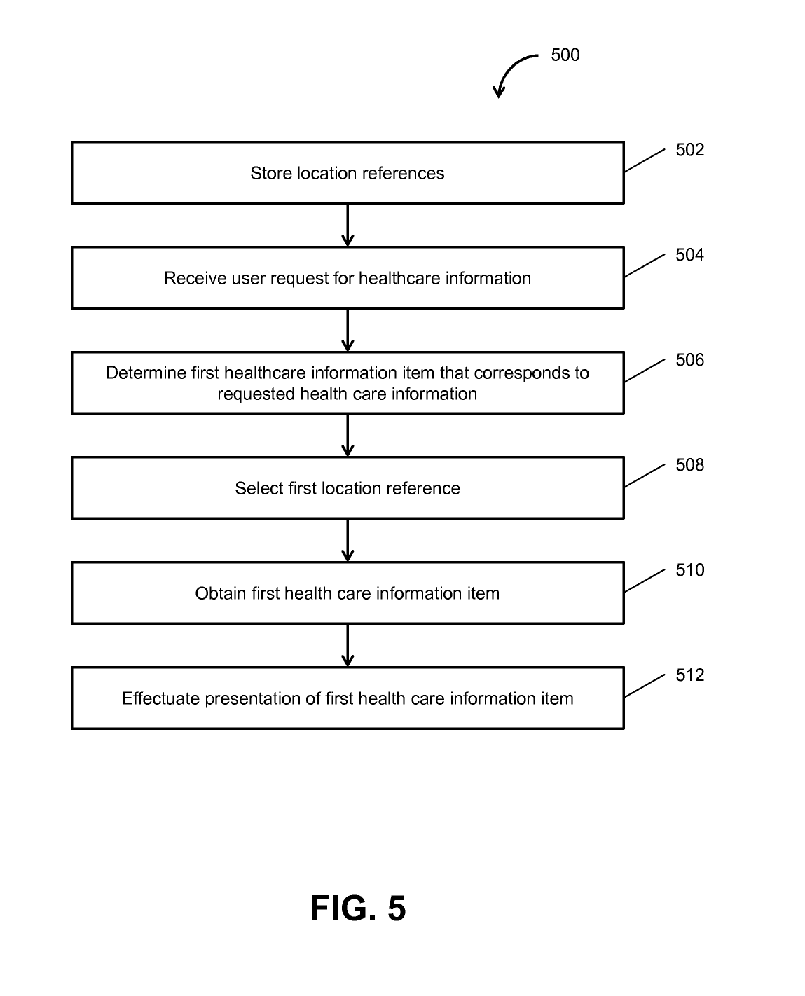

FIG. 5 illustrates a method for facilitating retrieval and presentation of health care information from multiple sources, according to an implementation. The operations of method 500 presented below are intended to be illustrative. In some implementations, method 500 may be accomplished with one or more additional operations not described, and/or without one or more of the operations discussed. Additionally, the order in which the operations of method 500 are illustrated in FIG. 5 and described below is not intended to be limiting.

In some implementations, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices programmed through hardware, firmware, and/or software to be specifically designed for execution of one or more of the operations of method 500.

At operation 502, location references associated with health care information items may be stored. The location references may indicate locations in a plurality of databases at which the health care information items may be stored. In an implementation, at least one of the health care information items may be associated with multiple ones of the location references. As an example, at least one of the health care information items may be stored in multiple locations in different databases, and each location reference of the multiple location references (with which the health care information item is associated) may indicate at least one of the locations at which the health care information item is stored. Operation 502 may be performed by a reference component that is the same as or similar to reference component 112, in accordance with one or more implementations.

At operation 504, a consumer request for health care information may be received. The requested health care information may be associated with an individual. Operation 504 may be performed by a request component that is the same as or similar to request component 118, in accordance with one or more implementations.

At operation 506, a first health care information item that corresponds to the requested health care information may be determined. Operation 506 may be performed by a determination component that is the same as or similar to determination component 120, in accordance with one or more implementations.

At operation 508, a first location reference associated with the first health care information item may be selected. The first location reference may, for example, indicate a first location (in one of the plurality of databases) at which the first health care information item is stored. As such, the first location reference may be used to obtain the first health care information item from the first location. The first location reference may be selected based on one or more resource criteria. Operation 508 may be performed by a location component that is the same as or similar to location component 122, in accordance with one or more implementations.

At operation 510, the first health care information item may be obtained from the first location (indicated by the first location reference). The first health care information item may be obtained based on the first location reference. Operation 510 may be performed by a health care information component that is the same as or similar to health care information component 110, in accordance with one or more implementations.

At operation 512, presentation of the first health care information item may be effectuated. In some implementations, presentation of the first health care information item may be effectuated for display on one or more consumer devices. In some implementations, effectuating presentation may include providing a feed to one or more consumers. In some implementations, the health care information item may be used in one or more processing components (e.g., a rules engine and/or analytics calculator). Operation 512 may be performed by a presentation component that is the same as or similar to presentation component 126, in accordance with one or more implementations.

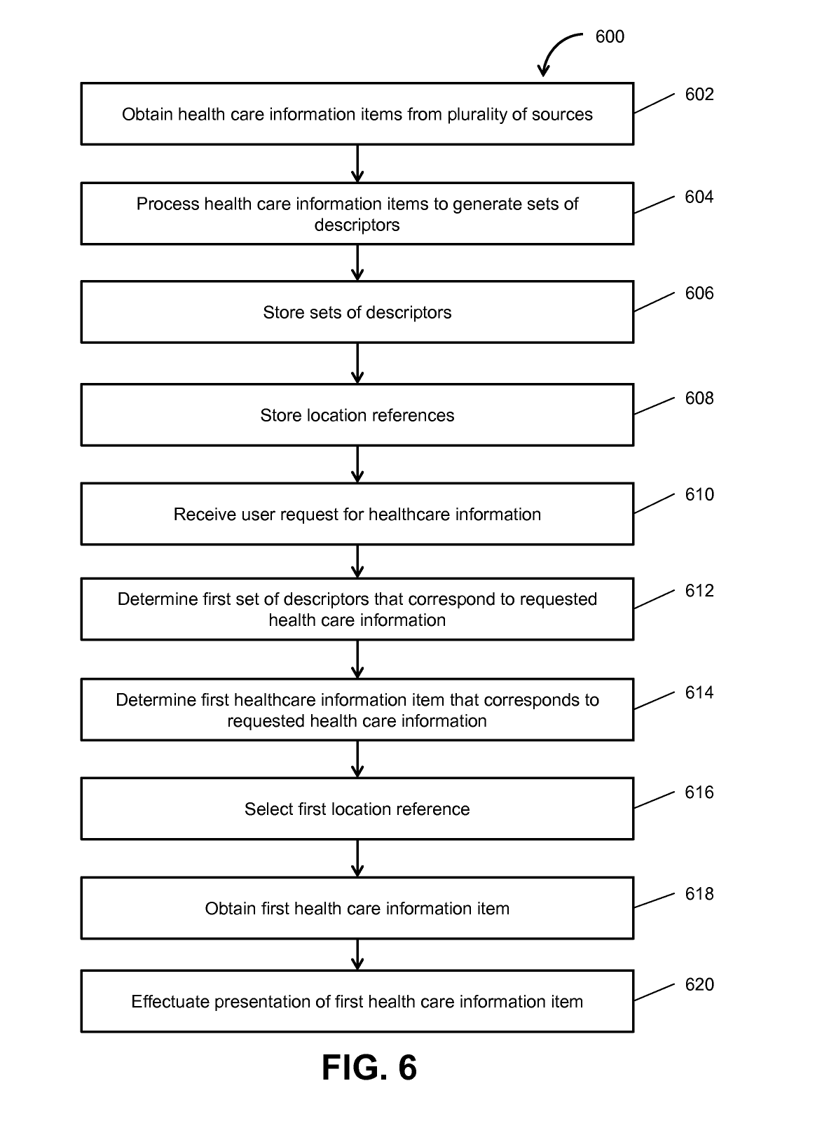

FIG. 6 illustrates a method for facilitating retrieval and presentation of health care information from multiple sources, according to an implementation. The operations of method 600 presented below are intended to be illustrative. In some implementations, method 600 may be accomplished with one or more additional operations not described, and/or without one or more of the operations discussed. Additionally, the order in which the operations of method 600 are illustrated in FIG. 6 and described below is not intended to be limiting.

In some implementations, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices programmed through hardware, firmware, and/or software to be specifically designed for execution of one or more of the operations of method 600.

At operation 602, heath information items may be obtained from a plurality of sources. A plurality of sources may be included in a plurality of databases. In an implementation, the plurality of sources may include one or more of electronic medical record platforms, electronic health record platforms, personal health record platforms and/or other sources. Operation 602 may be performed by a health care information component that is the same as or similar to health care information component 110, in accordance with one or more implementations.

At operation 604, the health care information items may be processed to generate sets of descriptors. The sets of descriptors may be associated with the health care information items. For example, each one of the sets of descriptors may comprise at least one descriptor describing at least one of the health care information items to which the one set of descriptors corresponds. Operation 604 may be performed by a processing component that is the same as or similar to processing component 114, in accordance with one or more implementations.

At operation 606, the sets of descriptors associated with the health care information items may be stored. Operation 606 may be performed by a processing component that is the same as or similar to processing component 114, in accordance with one or more implementations.

At operation 608 location references associated with health care information items may be stored. The location references may indicate locations in a plurality of databases at which the health care information items may be stored. In an implementation, at least one of the health care information items may be associated with multiple ones of the location references. As an example, at least one of the health care information items may be stored in multiple locations in different databases, and each location reference of the multiple location references (with which the health care information item is associated) may indicate at least one of the locations at which the health care information item is stored. Operation 608 may be performed by a reference component that is the same as or similar to reference component 112, in accordance with one or more implementations.

At operation 610, a consumer request for health care information may be received. The requested health care information may be associated with an individual. Operation 610 may be performed by a request component that is the same as or similar to request component 118, in accordance with one or more implementations.

At operation 612, a first set of descriptors that correspond to the requested health care information may be determined. Operation 612 may be performed by a determination component that is the same as or similar to processing component 114, in accordance with one or more implementations.

At operation 614, a first health care information item that corresponds to the requested health care information may be determined. The first health care information item may be determined based on the first health care information item being associated with the first set of descriptors. Operation 614 may be performed by a determination component that is the same as or similar to determination component 120, in accordance with one or more implementations.

At operation 616, a first location reference associated with the first health care information item may be selected. The first location reference may, for example, indicate a first location (in one of the plurality of databases) at which the first health care information item is stored. As such, the first location reference may be used to obtain the first health care information item from the first location. The first location reference may be selected based on one or more resource criteria. Operation 616 may be performed by a location component that is the same as or similar to location component 122, in accordance with one or more implementations.

At operation 618, the first health care information item may be obtained from the first location (indicated by the first location reference). The first health care information item may be obtained based on the first location reference. Operation 618 may be performed by a health care information component that is the same as or similar to health care information component 110, in accordance with one or more implementations.

At operation 620, presentation of the first health care information item may be effectuated. In some implementations, presentation of the first health care information item may be effectuated for display on one or more consumer devices. In some implementations, effectuating presentation may include providing a feed to one or more consumers. In some implementations, the health care information item may be used in one or more processing components (e.g., a rules engine and/or analytics calculator). Operation 620 may be performed by a presentation component that is the same as or similar to presentation component 126, in accordance with one or more implementations.

Although the system(s) and/or method(s) of this disclosure have been described in detail for the purpose of illustration based on what are currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system for facilitating retrieval and presentation of health care information from multiple sources, the system comprising:
one or more sources internal to the system; and
one or more physical computer processors configured by machine-readable instructions to:
store, at the one or more internal sources, location references associated with health care information items, wherein the location references indicate locations in a plurality of sources at which the health care information items are stored, and wherein at least one of the health care information items is associated with multiple ones of the location references, and the plurality of sources includes at least one source internal to the system and at least one source external to the system;
receive a consumer request for health care information associated with an individual;
determine, based on the consumer request, a first health care information item that corresponds to the requested health care information;
select, based on one or more availability criteria and one or more health data standard criteria, a first location reference associated with the first health care information item that is to be used to obtain the first health care information item from a first location in one of the plurality of sources, wherein the first location is indicated by the first location reference, and wherein the one or more availability criteria relate to current access availability of respective ones of the plurality of sources, the one or more health data standard criteria relate to health data standards offered via respective ones of the plurality of sources, and the first location reference is selected from multiple location references stored at the one or more internal sources and associated with the first health care information item such that the first location satisfies the one or more availability criteria and the one or more data standard criteria;
obtain, based on the first location reference, the first health care information item from the first location; and
effectuate presentation of the first health care information item.

2. The system of claim 1, wherein effectuating presentation of the first health care information item includes effectuating presentation for display on one or more consumer devices.

3. The system of claim 1, wherein effectuating presentation of the first health care information item includes providing a feed to one or more consumers.

4-5. (canceled)

6. The system of claim 1, wherein selecting the first location reference comprises selecting the first location reference from the multiple location references associated with the first health care information item based on one or more time criteria, the one or more availability criteria, and the one or more health data standard criteria.

7. The system of claim 1, wherein selecting the first location reference comprises selecting the first location reference from the multiple location references associated with the first health care information item based on one or more data type criteria, the one or more availability criteria, and the one or more health data standard criteria.

8-9. (canceled)

10. The system of claim 1, wherein the one or more physical computer processors are further configured by machine-readable instructions to:
obtain the health care information items from a plurality of sources;
process the health care information items to generate sets of descriptors associated with the health care information items, wherein each one of the sets of descriptors comprises at least one descriptor describing at least one of the health care information items to which the one set of descriptors corresponds;
store the sets of descriptors associated with the health care information items; and
determine, based on the consumer request and the sets of descriptors, a first set of descriptors that correspond to the requested health care information,
wherein determining the first health care information item comprises determining the first health care information item based on the first health care information item being associated with the first set of descriptors.

11. The system of claim 1, wherein the plurality of sources include one or more of electronic medical record platforms, electronic health record platforms, or personal health record platforms.

12. The system of claim 11, wherein the one or more physical computer processors are further configured by machine-readable instructions to:
normalize the first health care information item obtained from the first location,
wherein effectuating the presentation of the first health care information comprises effectuating presentation of the normalized first health care information item.

13. The system of claim 10, wherein the one or more physical computer processors are further configured by machine-readable instructions to:
normalize the health care information items obtained from the plurality of sources; and
store the normalized health care information items at one or more locations in at least one of the plurality of data stores,
wherein obtaining the first health care information item comprises obtaining, based on the first location reference, one of the normalized health care information items.

14. The system of claim 1, wherein the one or more physical computer processors are further configured by machine-readable instructions to:
determine, based on the consumer request, a second health care information item associated with the first health care information item;
obtain the second health care information item from a second location in one of the plurality of databases; and
effectuating presentation of the second health care information item with the presentation of the first health care information item.

15. The system of claim 14, wherein the first health care information item comprises a first clinical information item, and the second health care information item comprises a first insurance information item associated with the first clinical information item, and wherein the first clinical information item is presented with the first insurance information item based on the association of the first clinical information item and the first insurance information item with one another.

16. The system of claim 14, wherein the one or more physical computer processors are further configured by machine-readable instructions to:
obtain the health care information items from a plurality of sources;
process the health care information items to determine corresponding health care information items; and
associate the first health care information item with the second health care information item based on a determination that the first health care information item corresponds to the second health care information item.

17. A method for facilitating retrieval and presentation of health care information from multiple sources, the method being implemented on a computer system having one or more physical processors executing computer program instructions which, when executed, perform the method, the method comprising:
storing, by the computer system, at one or more sources internal to the computer system, location references associated with health care information items, wherein the location references indicate locations in a plurality of sources at which the health care information items are stored, and wherein at least one of the health care information items is associated with multiple ones of the location references, and the plurality of sources includes at least one source internal to the system and at least one source external to the system;
receiving, at the computer system, a consumer request for health care information associated with an individual;
determining, by the computer system, based on the consumer request, a first health care information item that corresponds to the requested health care information;
selecting, by the computer system, based on one or more availability criteria and one or more health data standard criteria, a first location reference associated with the first health care information item that is to be used to obtain the first health care information item from a first location in one of the plurality of sources, wherein the first location is indicated by the first location reference, and wherein the one or more availability criteria relate to current access availability of respective ones of the plurality of sources, the one or more health data standard criteria relate to health data standards offered via respective ones of the plurality of sources, and the first location reference is selected from multiple location references stored at the one or more internal sources and associated with the first health care information item such that the first location satisfies the one or more availability criteria and the one or more data standard criteria;
obtaining, by the computer system, based on the first location reference, the first health care information item from the first location; and
effectuating, by the computer system, presentation of the first health care information item.

18. The method of claim 17, wherein effectuating presentation of the first health care information item includes effectuating presentation for display on one or more consumer devices.

19. The method of claim 17, wherein effectuating presentation of the first health care information item includes providing a feed to one or more consumers.

20-21. (canceled)

22. The method of claim 17, wherein selecting the first location reference comprises selecting the first location reference from the multiple location references associated with the first health care information item based on one or more time criteria, the one or more availability criteria, and the one or more health data standard criteria.

23. The method of claim 17, wherein selecting the first location reference comprises selecting the first location reference from the multiple location references associated with the first health care information item based on one or more data type criteria, the one or more availability criteria, and the one or more health data standard criteria.

24-25. (canceled)

26. The method of claim 17, further comprising:
obtaining, by the computer system, the health care information items from a plurality of sources;
processing, by the computer system, the health care information items to generate sets of descriptors associated with the health care information items, wherein each one of the sets of descriptors comprises at least one descriptor describing at least one of the health care information items to which the one set of descriptors corresponds;
storing, by the computer system, the sets of descriptors associated with the health care information items; and
determining, by the computer system, based on the consumer request and the sets of descriptors, a first set of descriptors that correspond to the requested health care information,
wherein determining the first health care information item comprises determining the first health care information item based on the first health care information item being associated with the first set of descriptors.

27. The method of claim 26, wherein the plurality of sources include one or more of electronic medical record platforms, electronic health record platforms, or personal health record platforms.

28. The method of claim 27, further comprising:
normalizing, by the computer system, the first health care information item obtained from the first location,
wherein effectuating the presentation of the first health care information comprises effectuating presentation of the normalized first health care information item.

29. The method of claim 27, further comprising:
normalizing, by the computer system, the health care information items obtained from the plurality of sources; and
storing, by the computer system, the normalized health care information items at one or more locations in at least one of the plurality of databases,
wherein obtaining the first health care information item comprises obtaining, based on the first location reference, one of the normalized health care information items.

30. The method of claim 17, further comprising:
determining, by the computer system, based on the consumer request, a second health care information item associated with the first health care information item;
obtaining, by the computer system, the second health care information item from a second location in one of the plurality of sources; and
effectuating, by the computer system, presentation of the second health care information item with the presentation of the first health care information item.
